(19) United States
(12) Patent Application Publication
(10) Pub. No.: US 2003/0066377 A1
(43) Pub. Date: Apr. 10, 2003

(54) Motorcycle control lever

(76) Inventors: Nir Yosef Spaizar, Petach-Tikva (IL); Dekel Bar, Moshav Zaparia (IL); Nave Natan Lev-Ran, Moshav Shdemot Dvora (IL); Boaz Agayoff, Holon (IL)

Correspondence Address: WILLIAM H. DIPPERT, REED SMITH LLP, 599 LEXINGTON AVENUE, 29TH FLOOR, NEW YORK, NY, 10022-7650, US

(21) Appl. No.: 09/974,140

(22) Filed: Oct. 10, 2001

(51) Int. Cl. B62K 21/12

(52) U.S. Cl. 74/551.1

(57) ABSTRACT

A motorcycle control lever including a flexible portion that absorbs force and/or energy of an impact, preventing or reducing damage to a rigid part thereof.

### FIELD OF THE INVENTION

The present invention relates to a motorcycle control lever.

### BACKGROUND OF THE INVENTION

The present invention relates to a motorcycle control lever that is subject to strong forces beyond regular operating forces. These strong forces are incurred, for instance, when a moving motorcycle overturns or impacts a stationary object, as can happen during sport motorcycling. Many control levers are prominently positioned so they ate commonly subject to great impact force and, because they are made of rigid materials (ego, plastic, aluminum, magnesium or steel), are damaged irreparably. Examples of commonly damaged control levers are the levers that protrude from motorcycle handlebars and foot levers.

Stegall, et al. (U.S. Pat. No. 5,873,284) demonstrates a control lever including a spring section to allow control while a motor is mounted as a backpack and the operator is in motion. Forces incurred when the motor is moving beyond walking speed are not contemplated and hence this invention is not relevant to high speed motorcycles.

Smith, et al. (U.S. Pat. No. 4,009,623) and V. Tripp (U.S. Pat. No. 3,733,922) demonstrate motorcycle control levers that are flexible their entire length. Such levers are designed to withstand a force caused by an object that sideswipes the control lever from a specific angle while the motorcycle is in motion. Direct impact by a stationary object or a sideswiping impact during motion from an angle not specific to the desire, are not contemplated.

Warren, et al. (U.S. Pat. No. 6,047,611) disclose a control lever for motorcycles which collapses under force when the force is applied from a specific angle in relation to the lever. Force from an unanticipated angle or by a stationary object while moving is not contemplated.

### SUMMARY OF THE INVENTION

An aspect of some embodiments of the present invention relates to increasing the impact resistance of a motorcycle control lever to impact forces by replacing a rigid section of the lever with a flexible section that absorbs and/or disperses impact and bending forces and/or energies to prevent lever damage. The dispersion may be, for example temporal and/or spatial.

In an exemplary embodiment, the motorcycle control lever is made of two parts, a non-flexible lever body and a flexible impactor. The lever body is attached at one end to a mounting that controls a function of the motorcycle and, at its other end, to an impactor. The impactor is composed of flexible material.

For the purposes of this application a flexible material is defined as a material that reduces an impact of a large, sudden force and bends under a strong bending force. Reduction in force impact means that the flexible material temporally spreads out a large, sudden force, thereby reducing impulse amplitude. A flexible material additionally bends under force to 15 degrees, possibly even as much as 30 or 90, 140 or even 180 degrees, depending on the implementation and/or particular impact force, diverting and/or spreading the damaging bending force front causing damage along the part. A flexible material is further defined as a material that returns automatically to an unbent position following resolution of the force, while remaining substantially rigid under normal operating forces.

In an embodiment of the present invention, the impactor is attached at one end to the lever body with its other end being the free end of the control lever. It functions as an extension to the lever body under normal operating forces and demonstrates flexible properties under forces greater than operating forces.

In some embodiments of the invention, the free end of the impactor has a rigid section so the flexible section of the impactor is positioned between the lever body and a rigid section attached to its free end. Upon impact, the force is transmitted through the rigid section at the free end of the impactor to the imp actor where the force is modified to prevent damage to the lever body.

There is thus provided in accordance with an exemplary embodiment of the invention, a motorcycle control lever, comprising:

a rigid lever body;

a mounting connector on a proximal end of said lever body, adapted for attaching said lever to a motorcycle lever mounting; and

an impact absorbing section formed of a flexible material, wherein;

said impact absorbing section does not significantly flex under normal operating forces of said lever. Optionally, said impact absorbing section is mounted on a distal end of said lever body. Alternatively, said lever body is split into two parts and said impact absorbing section is mounted between said two parts.

In an exemplary embodiment of the invention, said impact absorbing section is snap-mounted onto a jut in said body. Alternatively, said impact absorbing section is cast onto said body. Alternatively, said impact absorbing section is molded onto said body.

In an exemplary embodiment of the invention, said lever defines a main axis and wherein said lever yields less than 5° per Kg of force applied to a distal end of said lever. Optionally, said lever yields less than 2° per Kg of force applied to a distal end of said lever.

Alternatively or additionally, said lever yields at least 15° under an impact of over 20 Kg. Alternatively or additionally, said lever yields at least 90° under an impact of over 100 Kg.

In an exemplary embodiment of the invention, said impact absorbing section reduces a maximum impact force by at least 20%. Optionally, said impact absorbing section reduces a maximum impact force by at least 40%.

Alternatively or additionally, said impact absorbing section absorbs at least 20% of an energy of an impact. Optionally, said impact absorbing section absorbs at least 40% of an energy of an impact.

In an exemplary embodiment of the invention, said impact absorbing section is at least 20% of a length of said lever. Optionally, said impact absorbing section is at least 40% of a length of said lever.

In an exemplary embodiment of the invention, said lever is a hand level. Alternatively, said lever is a foot lever.

There is also provided in accordance with an exemplary embodiment of the invention, a motorcycle including a hand control lever as described herein.

### BRIEF DESCRIPTION OF THE DRAWINGS

Exemplary non-limiting embodiments of the invention will be described with reference to the following description of embodiments in conjunction with the figures. Identical structures, elements or parts which appear in more than one figure are preferably labeled with a same or similar number in all the figures in which they appear.

FIGS. 1A and 1B illustrate perspective views of a motorcycle control lever according to an embodiment of the present invention;

FIG. 2 illustrates a lever body and an impactor according to an exemplary embodiment of the present invention;

FIG. 3 illustrates the impactor of FIG. 2, attached to the lever body from FIG. 2 according to an embodiment of the present invention; and

FIGS. 4A and 4B illustrate top and side views of an alternative motorcycle control lever according to an embodiment of the present invention.

### DETAILED DESCRIPTION OF EMBODIMENTS

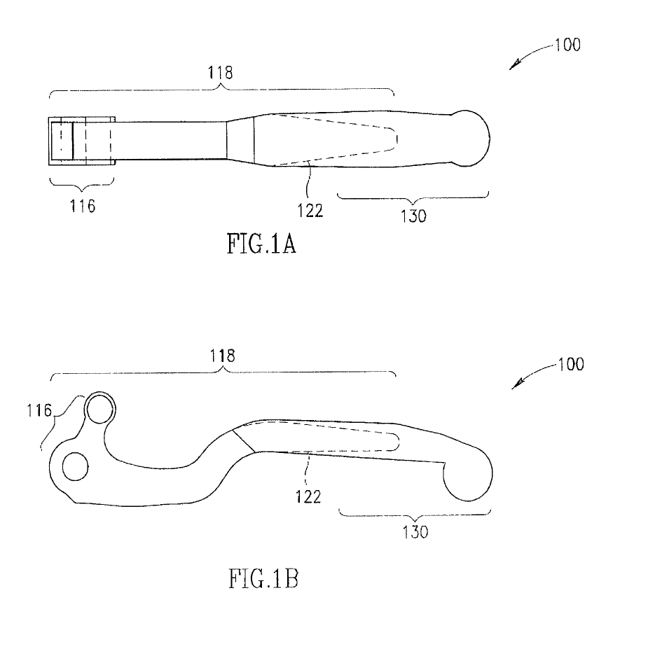

FIGS. 1A and 1B illustrate perspective views of a motorcycle control lever 100 with a lever body 118 and an impactor 130 according to an embodiment of the present invention. Control lever 100 attaches via a mounting connector 116 to a mounting on the motorcycle that controls a motorcycle function, such as braking or clutch.

In an exemplary embodiment, control lever 300 is not damaged by forces such as impact from a stationary object while the motorcycle is in motion. A large force, when applied to the end of control lever 100 travels along impactor 130 which optionally reduces the impact of the force that is transmitted to lever body 118. This diminished force rate of change allows the lever body 118 to be subject to the force without breaking. Alternatively or additionally, when a bending force is transmitted along lever 100, it causes impactor 130 to bend (rather than body 118), diminishing the bending force transmitted to lever body 118 and mounting connector 116 so lever 100 is not damaged. In some cases, impactor 130 also absorbs significant amounts of force.

In an exemplary embodiment of the invention, impactor 130 is made rigid enough so that, due to its location along lever 100 and its degree of rigidity, when a user uses lever 100. the lever does not give in a manner that would affect the user control. This is also due, for example, to the part of the hand (e.g., the pinkie fingers) that contacts impactor 130. However, impactor 130 typically bears the brunt of any impact,

In an exemplary embodiment of the invention, impactor 130 is molded or cast onto lever 100. Alternatively, it may be attached mechanically by screws or other attachment elements or mechanically.

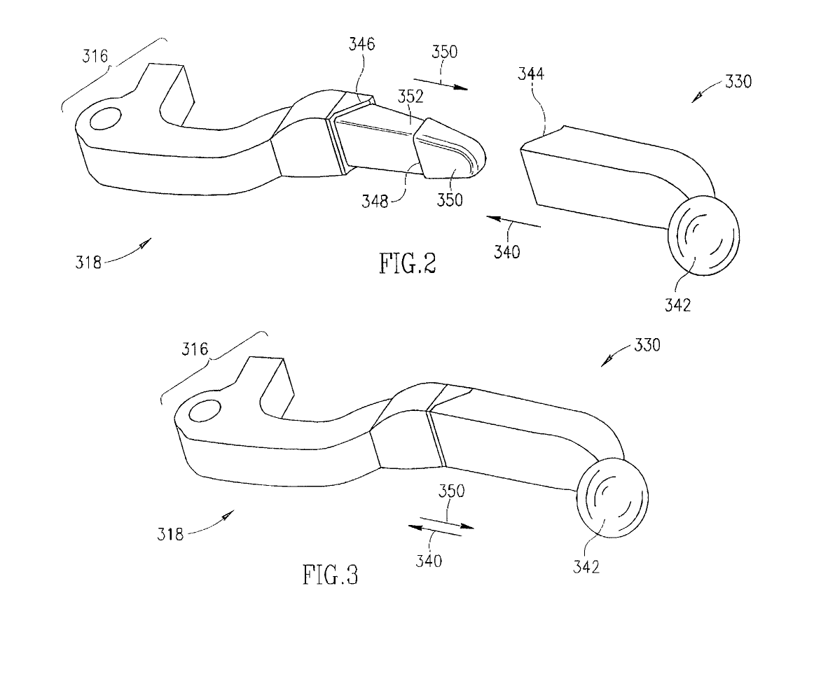

FIG. 2 illustrates an exemplary embodiment of a lever body 318 of the present invention with impactor 330 removed to show raised stops which mechanically lock impactor 330 onto lever body 318. Impactor 330 is hollow and fits over lever body 31S. A lead stop 346 of lever body 318 abuts against a lead 344 of impactor 330 and locks movement in direction 340 so impactor 330 cannot move toward a mounting connector 316. A plateau 352 of lever body has a corner step 348. When lever body 318 is moved in the direction of an arrow 350 and impactor 330 in the direction of an arrow 340, the two parts are couple, as shown for example in FIG. 3. In an exemplary embodiment of the invention, impactor 330 includes one or more an inner protrusions that interlock with step 348 and stop 346.

Alternative locking mechanisms to lock impactor 330 on lever body 318, are also possible, for example, other interlocking schemes that match the two pieces, screws, bolts or pins placed through impactor 330 and lever body 318 or a variety of bonding agents can be used to attach the impactor to the lever body. Other mechanical locking mechanisms may be used as well. One advantage of some types of mechanical locking is that if impactor 330 breaks, it can be field replace.

In another example, impactor 130 is molded on a threading formed at the end of lever body 118. Alternatively, impactor 130 is screwed onto such a threading.

Motorcycles can have a large variety of part variation and mounting connector 316 shows a somewhat different design than that of mounting connector 116 of lever body 118 in FIGS. 1A and 1B. Such design variations are within the scope of this invention as are changes within the design of lever 100. Further, lever 100 can be located in any number of locations on a motorcycle besides the handlebars, such as below the handlebars, the foot area, behind die seat and etc., each having design variation for optimal use and ornamentation. All such motorcycle control lever locations, designs and ornamentation are within the scope of this invention, albeit, different locations may require different degrees of resistance to bending under normal operating forces and/or different degrees of response to impact forces. In an exemplary embodiment of the invention, a foot lever, which has a general shape of a “U” has a flexible impactor formed as one arm of the “U” (the inner arm or the outer arm), or as a part of this arm or as the base of the “U”. It should be noted however, that hand levers often have higher specifications, for example, requiring that a tactile feel of the lever be correct (e.g., feel substantially rigid) and/or require a minimum length. In addition, with hand levers the part that is affected by the impact is often not the part to which a maximum manual force is applied.

FIG. 2 also illustrates an exemplary design embodiment of impactor 330 of the present invention. Impactor 330 has an optional round flexible adornment 342 that serves to absorb shock. Design enhancements may be added to adornment 342 or other sections of impactor 330 or lever body 318 including, for example, an identifying moniker, a tassel. Blinking LEDs or name of the manufacturer or inventor. It should be noted that plastic materials are often more amenable for attaching/embedding/forming ornaments than metal.

It is within the scope of this invention that impactor 330 can be made from any one of a variety of materials that are flexible (as defined above), including silicone such as silicone polymer. Alternatively or additionally, composite materials are used, for example, a polymer with fibers embedded in it. In an exemplary embodiment of the invention, impactor 330 is formed of a polyurethane elastomer with a shore A hardness of 99. A range of hardness may be suitable, for example, 80-130, depending on the impactor geometry, including, for example, the impactor length and cross-section and the lever function, for example, a force/impact threshold under which the lever will break and a natural yield of the control mechanism of the lever. In one example, the lever is made to yield less than 20%, 10%, 5% or any intermediate, larger or smaller percentage of the yield of the control mechanism of the lever, in the direction of the natural level motion. In other directions, the yield may be higher or lower, depending, for example on the normal forces typically applied by a user in these directions.

In an exemplary embodiment of the invention, impactor 330 is designed to have a minimal impact on normal handling of the lever. In the case where impactor 330 is only at the tip of the lever, it has relatively small forces applied to it. In any case, impactor 330 is desirably designed to bend little if at all to manual operating forces and to bend significantly under impact forces of accidents and/or forces which approach magnitudes that can damage the rigid part of the lever. Optionally, impactor 330 is made harder (e.g., slower responding) to allow it to absorb the full range of forces expected in use. Thus, for example, if impactor 330 is made too soft, a very strong impact may bend it completely and then transfer a significant remaining impact to the lever, damaging the lever.

In an exemplary embodiment of the invention, impactor 330 absorbs at least 10%, 20%, 40%, 60% or any smaller, intermediate or greater percentage of the total impact energy, so that this energy does not reach the rest of the lever. Alternatively or additionally, impactor 330 reduces the maximum impact force transmitted through it by at least 10%, 20%, 40%. 60% or any smaller, intermediate or greater percentage of the maximum impact force, so that even if the energy reaches the lever body, it is more spread out over time.

In an exemplary embodiment of the invention, a handle lever is designed to bend about 1.6° for each Kg of force applied to the tip of the lever in the plane of the motion of the lever. The same lever is designed to bend 2° for each Kg of force applied in a plane perpendicular to the motion of the lever. These are only exemplary numbers an depend, for example, oil the length of impactor 330 and the regular operating forces applied in these directions. Thus, for example, a different impactor may yield only 0.5° (e.g., a foot lever) for each Kg, 3° per Kg or as much as 5° for each Kg (e.g., a finger lever). The exact degree of yielding can also depend on the total applied force. These angles can be measured, for example, by applying a force at a base of ornament 342 and measuring the movement of the tip of the ornament, relative to an original axis of the lever. In general, the angle of yielding may be changed, for example, by changing the hardness of the impactor, changing the length of the impactor and/or changing its cross-section.

In an exemplary embodiment of the invention, the length of impactor 130 is 10%, 20%. 30%, 40% or any smaller, greater or intermediate percentage of the length of lever 100. The length may also be determined to allow the impactor to bend under impact without exceeding its elastic limits and/or breaking.

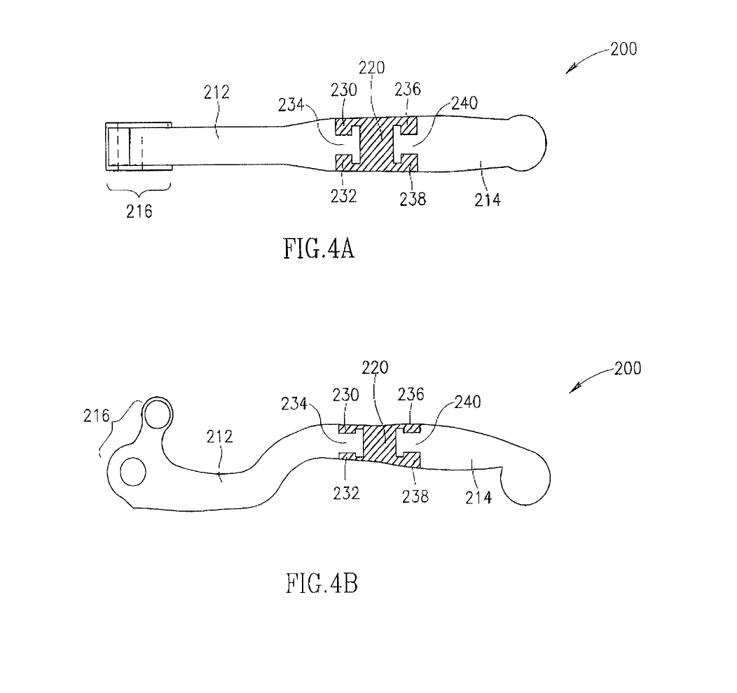

FIGS. 4A and 4B illustrate a perspective view of a control lever 200, according to an exemplary embodiment of the present invention, with an impactor 220 positioned between a lever body 212 and a hard end 214. In this embodiment, force is transmitted from hard end 214 impactor 220 which both absorbs force and bends to prevent damage to lever body 212 and to mounting connector 216.

Impactor 220 has lever feet 230 and 232 (or a complete ring) that encompass a lever body jut 234 to bind impactor 220 to lever body 212. Impactor 220 also has hard end feet 236 and 238 that encompass a hard end jut 240 to bind impactor 220 to hard end 214. impactor 220 is shown as if it were transparent, for clarity. In a typical embodiment, juts 234 and 240 are enclosed and hidden by impactor 220.

This alternative position of impactor 220 over impactor 130 is but one of many that are within the scope of this invention; any section of lever body 212, impactor 220 or hard end 214 could be replaced with a section of impactor 220 of varied size and design.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. For example, the method of attachment can vary, for example, being adhesive based or using other mechanical attachment means such as screws or bolts. Furthermore, the terms “comprise,” “include,” “have” and their conjugates, shall mean, when used in the claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, toe scope of the invention is limited only by the elements and limitations as used in the claims.

1. A motorcycle control lever, comprising:
a rigid lever body;
a mounting connector on a proximal end of said lever body, adapted for attaching said lever to a motorcycle lever mounting; and
an impact absorbing section formed of a flexible material, wherein;
said impact absorbing section does not significantly flex under normal operating forces of said lever.

2. A lever according to claim 1, wherein said impact absorbing section is mounted on a distal end of said lever body.

3. A lever according to claim 1, wherein said lever body is split into two parts and said impact absorbing section is mounted between said two parts.

4. A lever according to claim 1, wherein said impact absorbing section is snap-mounted onto a jut in said body.

5. A lever according to claim 1, wherein said impact absorbing section is cast onto said body.

6. A lever according to claim 1, wherein said impact absorbing section is molded onto said body.

7. A lever according to claim 1, wherein said lever defines a main axis and wherein said lever yields less than 5° per Kg of force applied to a distal end of said lever.

8. A lever according to claim 1, wherein said lover defines a main axis and wherein said lever yields less than 2° per Kg of force applied to a distal end of said lever.

9. A lever according to claim 1, wherein said lever defines a main axis and wherein said lever yields at least 15° under an impact of over 20 Kg.

10. A lever according to claim 1, wherein said lever defines a main axis and wherein said lever yields at least 90° under an impact of over 100 Kg.

11. A lever according to claim 1, wherein said impact absorbing section reduces a maximum impact force by at least 20%.

12. A lever according to claim 1, wherein said impact absorbing section reduces a maximum impact force by at least 40%.

13. A lever according to claim 1, wherein said impact absorbing section absorbs at least 20% of all energy of an impact.

14. A lever according to claim 1, wherein said impact absorbing section absorbs at least 40% of an energy of an impact.

15. A lever according to claim 1, wherein said impact absorbing section is at least 20% of a length of said lever.

16. A lever according to claim 1, wherein said impact absorbing section is at least 40% of a length of said lever.

17. A lever according to claim 11 wherein said lever is a hand lever.

18. A lever according to claim 1, wherein said lever is a foot lever.

19. A motorcycle including a hand control lever according to claim 1.
